(19) United States
(12) Patent Application Publication
(10) Pub. No.: US 2026/0099016 A1
(43) Pub. Date: Apr. 9, 2026

(54) ELECTRONIC DEVICE

(71) Applicant: Advanced Semiconductor Engineering, Inc., Kaohsiung (TW)

(72) Inventors: Jr-Wei LIN, Kaohsiung (TW); Hung-Yi LIN, Kaohsiung (TW)

(73) Assignee: Advanced Semiconductor Engineering, Inc., Kaohsiung (TW)

(21) Appl. No.: 18/906,117

(22) Filed: Oct. 3, 2024

(51) Int. Cl. G02B 6/42

(52) U.S. Cl. CPC G02B 6/4214; G02B 6/423; G02B 6/4246

(57) ABSTRACT

An electronic device is provided. The electronic device includes a photonic component and an optical director. The photonic component includes an optical channel. The optical director includes a first director structure and a second director structure and is rotationally symmetric with respect to a center axis of the optical director. The optical director is configured to optically couple an optical signal from the optical channel along a first substantially horizontal path toward a non-horizontal path.

### BACKGROUND

### 1. Technical Field

The present disclosure relates generally to an electronic device.

### 2. Description of the Related Art

Typically, a photonic component is usually optically coupled to optical fibers by edge coupling between the optical fibers and waveguides exposed by an edge of the photonic component. Therefore, it would be difficult to perform an optoelectronic inspection on a wafer-level photonic structure, which may be performed from above the wafer-level photonic structure instead of from edges thereof, unless a singulation operation is performed to expose the waveguides from edges of the singulated photonic structure. However, such process may increase the processing time and the costs.

### SUMMARY

In one or more arrangements, an electronic device includes a photonic component and an optical director. The photonic component includes an optical channel. The optical director includes a first director structure and a second director structure and is rotationally symmetric with respect to a center axis of the optical director. The optical director is configured to optically couple an optical signal from the optical channel along a first substantially horizontal path toward a non-horizontal path.

In one or more arrangements, an electronic device includes a photonic component and an optical director. The photonic component includes an optical channel. The optical director includes a first optical module and a second optical module assembled to each other to collectively construct a substantially symmetric structure. The optical director is configured to optically couple to the optical channel and direct an optical signal transmitted along at least two different directions.

In one or more arrangements, an electronic device includes a photonic component, a first director structure, and a second director structure. The photonic component includes a plurality of optical channels. The first director structure includes a first recess and is configured to switch a transmission direction of a plurality of optical signals from the optical channels. The second director structure includes a second recess and is configured to switch the transmission direction of the optical signals from the first director structure. The first recess and the second recess define a rotationally symmetric cross-sectional profile.

### BRIEF DESCRIPTION OF THE DRAWINGS

Aspects of the present disclosure are better understood from the following detailed description when read with the accompanying drawings. It is noted that various features may not be drawn to scale, and the dimensions of the various features may be arbitrarily increased or reduced for clarity of discussion.

FIG. 1A is a cross-section of an electronic device in accordance with some arrangements of the present disclosure.

FIG. 1B is a cross-section of a portion of an electronic device in accordance with some arrangements of the present disclosure.

FIG. 1C is a top view of an electronic device in accordance with some arrangements of the present disclosure.

FIG. 1D is a cross-section of a portion of an electronic device in accordance with some arrangements of the present disclosure.

FIG. 2A is a cross-section of an electronic device in accordance with some arrangements of the present disclosure.

FIG. 2B is a cross-section of a portion of an electronic device in accordance with some arrangements of the present disclosure.

FIG. 2C is a top view of an electronic device in accordance with some arrangements of the present disclosure.

FIG. 3A is a top view illustrating one or more stages of an exemplary method for manufacturing an electronic device in accordance with some arrangements of the present disclosure.

FIG. 3B is a cross-section illustrating one or more stages of an exemplary method for manufacturing an electronic device in accordance with some arrangements of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

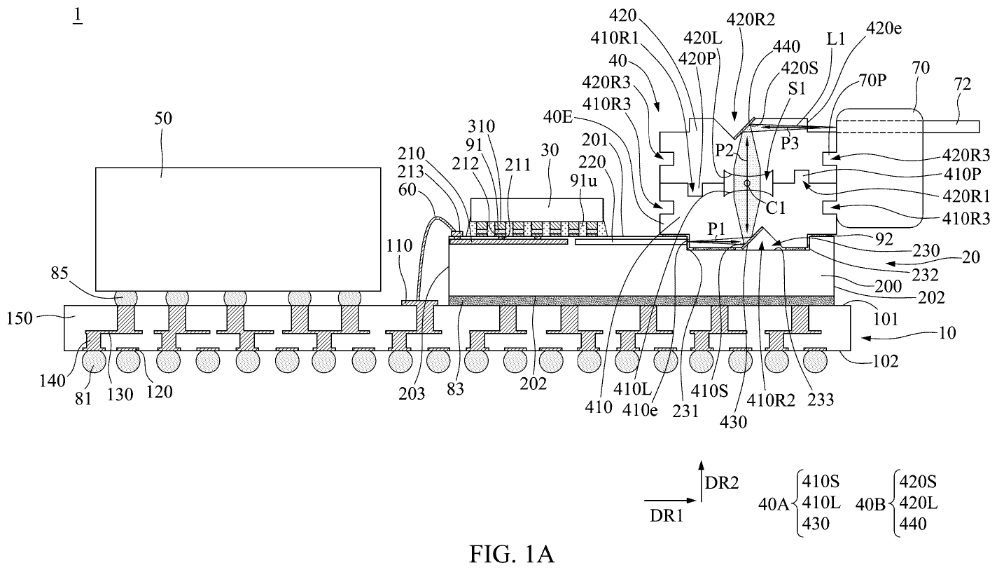

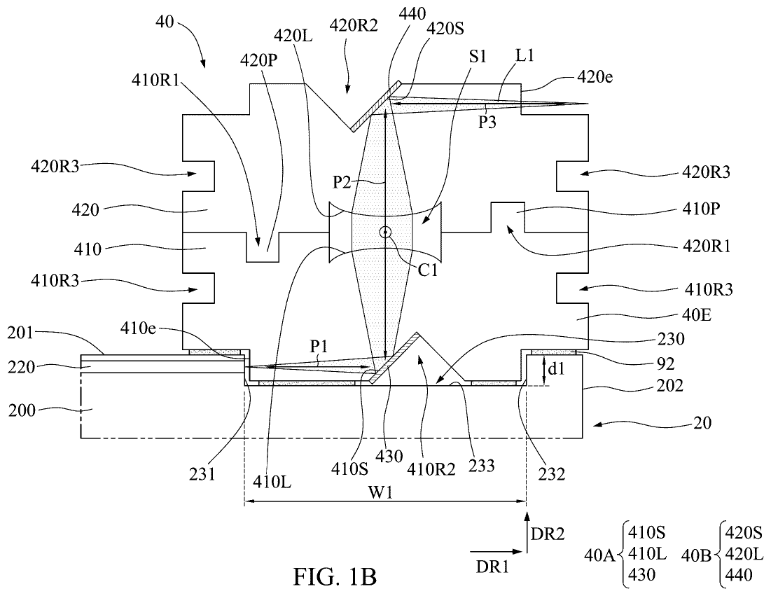

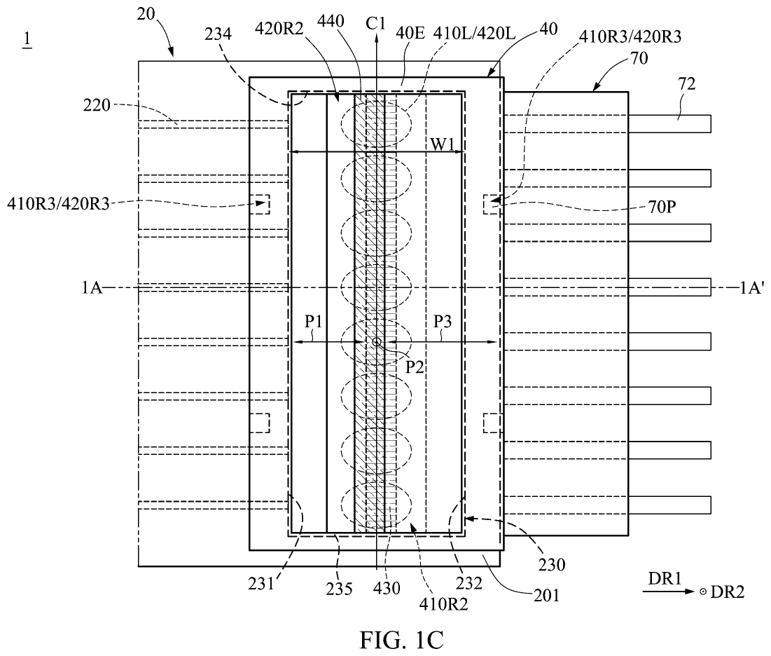

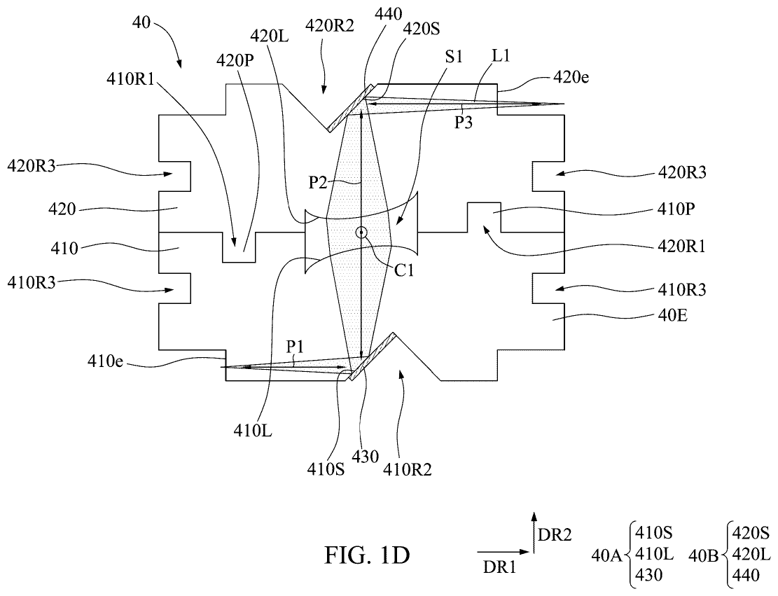

FIG. 1A is a cross-section of an electronic device 1 in accordance with some arrangements of the present disclosure. FIG. 1B is a cross-section of a portion of an electronic device 1 in accordance with some arrangements of the present disclosure. The electronic device 1 may include a substrate 10, a photonic component 20, electronic components 30 and 50, an optical director 40, a conductive wire 60, an optical component 70, electrical contacts 81, adhesive elements 83 and 92, and connection elements 85 and 91.

The substrate 10 may support the photonic component 20 and the electronic component 30. The substrate 10 may include, for example, a printed circuit board, such as a paper-based copper foil laminate, a composite copper foil laminate, or a polymer-impregnated glass-fiber-based copper foil laminate. The substrate 10 may include an interconnection structure, such as a plurality of conductive traces and/or a plurality of conductive vias. In some arrangements, the substrate 10 includes a ceramic material, a metal plate, an organic substrate, or a leadframe. In some arrangements, the substrate 10 may include a two-layer substrate which includes a core layer and a conductive material and/or structure disposed on an upper surface and a bottom surface of the substrate 10. The conductive material and/or structure may include a plurality of conductive traces.

The substrate 10 may have a surface 101 (also referred to as a top surface or an upper surface) and a surface 102 (also referred to as a bottom surface or a lower surface) opposite to the surface 101. In some arrangements, the substrate 10 includes conductive pads 110 and 120, conductive layers 130 (or conductive traces), conductive vias 140, and a dielectric structure 150. The dielectric structure 150 may include a plurality of dielectric layers. In some arrangements, the conductive layers 130 and the conductive vias 140 that electrically connect to the conductive layers 130 and the conductive pads 110 and 120 are within the dielectric layers of the dielectric structure 150. The conductive pads 110 and 120, the conductive layers 130, and the conductive vias 140 may independently include a conductive material, such as a metal or metal alloy. Examples include gold (Au), silver (Ag), aluminum (Al), copper (Cu), or an alloy thereof. The dielectric structure 150 may include, for example, one or more organic materials (e.g., phosphoric anhydride (PA), polyimide (PI), polybenzoxazole (PBO), epoxy, and an epoxy-based material) or one or more inorganic materials (e.g., silicon oxide, silicon nitride, glass, and ceramic).

The photonic component 20 may be disposed over the substrate 10. In some arrangements, the photonic component 20 is configured to provide a photoelectric conversion. In some arrangements, the photonic component 20 is configured to communicate optical signals L1 (or modulated optical signals L1). The one or more optical signals L1 may be designated as L1. The photonic component 20 may include a photonic integrated circuit (PIC), a laser diode, a receiver, a waveguide, a photodetector, a photodiode, a semiconductor optical amplifier (SOA), a grating coupler, a fiber coupling structure, an optical modulator (e.g., Mach-Zehnder modulator or microring modulator), or a combination thereof.

In some arrangements, the photonic component 20 includes a circuit layer 210, conductive elements 211, conductive pads 212 and 213, and one or more optical channels 220. The circuit layer 210 may include a combination of photonic devices, e.g., a PIC, a photodetector, a photodiode, a SOA, an optical modulator, or a combination thereof. The conductive elements 211 may include conductive traces and/or conductive vias that electrically connect the circuit layer 210 to the conductive pads 212 and 213. In some arrangements, the optical channel 220 is or includes an optical waveguide.

The photonic component 20 may have a surface 201 (also referred to as a top surface or an upper surface) and a surface 202 (also referred to as a bottom surface or a lower surface) opposite to the surface 201. In some arrangements, the photonic component 20 defines a recess 230 recessed from the surface 201 of the photonic component 20. In some arrangements, the optical channel 220 is exposed to the recess 230. The recess 230 may be defined by at least surfaces 231, 232, and 233 of the photonic component 20. In some arrangements, the optical channel 220 is exposed to the recess 230 by the surface 231. In some arrangements, the recess 230 is formed by etching (e.g., dry etching), the photonic component 20 is singulated by mechanical cutting (e.g., blade saw), and thus a roughness of the surface 231 is less than a roughness of lateral surfaces 203 and 204 of the photonic component 20. In some arrangements, the roughness of the surface 231 is less than 1 μm. In some arrangements, a depth d1 of the recess 230 may be from about 20 μm to about 40 μm, from about 25 μm to about 35 μm, or about 30 μm. In some arrangements, a width W1 of the recess 230 is from about 0.8 mm to about 1.2 mm, from about 0.9 mm to about 1.1 mm, or about 1 mm. In some arrangements, a thickness of the optical channel 220 is from about 10 μm to about 30 μm or from about 15 μm to about 25 μm.

The electronic component 30 may be disposed over the substrate 10. In some arrangements, the electronic component 30 is disposed over and electrically connected to the photonic component 20. In some arrangements, the electronic component 30 is configured to control modulation of optical signals L1. In some arrangements, the electronic component 30 is configured to amplify electrical signals. In some arrangements, the electronic component 30 is configured to amplify electrical signals received from the photonic component 20, for example, a photodetector of the photonic component 20. The electronic component 30 may include an electronic integrated circuit (EIC), which may be or include a modulator driver (DRV), a trans-impedance amplifier (TIA), or a combination thereof.

In some arrangements, the electronic component 30 includes conductive pads 310 exposed by or disposed on an active surface of the electronic component 30. In some arrangements, the electronic component 30 is electrically connected to the photonic component 20 through the connection elements 91. In some arrangements, the conductive pads 310 are electrically connected to the conductive pads 212 through the connection elements 91, and a protective element 91u further encapsulates the connection elements 91. The connection elements 91 may be or include conductive bumps, e.g., solder bumps. The protective element 91u may be or include an underfill.

The optical director 40 may be disposed over and optically couple to the photonic component 20. In some arrangements, the optical director 40 is partially in the recess 230. In some arrangements, the recess 230 of the photonic component 20 is configured for accommodating a portion of the optical director 40. In some arrangements, the optical director 40 includes an edge portion 40E supported by the surface 201 (e.g., the upper surface) of the photonic component 20. In some arrangements, a width of the edge portion 40E is greater than a depth d1 of the recess 230. In some arrangements, a width of the edge portion 40E is from about 150 μm to about 250 μm, from about 180 μm to about 230 μm, or about 200 μm.

In some arrangements, the optical director 40 is configured to optically couple to one or more optical channels 220. In some arrangements, the optical director 40 is partially in the recess 230 and configured to receive one or more optical signals L1 from one or more optical channels 220. In some arrangements, the optical director 40 is configured to direct one or more optical signals L1 from transmission in a substantially horizontal direction (e.g., a direction DR1) to a non-horizontal direction (e.g., a direction DR2). In some arrangements, the optical director 40 is configured to optically couple one or more optical signals L1 from a substantially horizontal path (e.g., a path P1) toward a non-horizontal path (e.g. the path P2). In some arrangements, the optical director 40 is configured to optically couple one or more optical signals L1 from the optical channel 220 along a substantially horizontal path (e.g., a path P1) toward a non-horizontal path (e.g. the path P2). As the optical signal L1 (or light) may keep diverging when switching its propagating direction, the path P2 may indicate a path that is substantially perpendicular to the surface 101, as shown by the labeling designated as “P2” in FIG. 1A. In addition, the path P2 may also indicate a path that is inclined with respect to the surface 101, which is non-vertical and non-parallel to the path P1, as shown by the diverged shape of the optical signal L1 in FIG. 1A.

In some arrangements, the optical director 40 is configured to further direct the one or more optical signals L1 from transmission in the non-horizontal direction (e.g., the direction DR2) to a substantially horizontal direction (e.g., the direction DR1) to optically couple the one or more optical signals L1 to an optical component 70 external to the optical director 40. In some arrangements, the optical director 40 is configured to optically couple the one or more optical signals L1 from the non-horizontal path (e.g. the path P2) toward another substantially horizontal path (e.g., a path P3) to optically couple the one or more optical signals L1 to an optical component 70 external to the optical director 40. In some arrangements, the optical director 40 is configured to optically couple one or more optical signals L1 from along a non-horizontal path (e.g. the path P2) toward a substantially horizontal path (e.g., the path P3). In some arrangements, the path P3 is configured to optically couple to a plurality of optical fibers 72 external to the optical director 40.

The optical director 40 includes optical modules 410 and 420. In some arrangements, the optical modules 410 and 420 are assembled to each other to collectively construct a substantially symmetric structure. In some arrangements, the optical modules 410 and 420 are assembled to each other to collectively construct a substantially rotationally symmetric structure. In some arrangements, the optical modules 410 and 420 are exposed to air without being encapsulated by an encapsulant. In some other arrangements, the optical modules 410 and 420 may be covered with one or more protective elements (e.g., an encapsulant).

In some arrangements, the optical module 410 has an edge 410e within the recess 230 and configured receive one or more optical signals L1 from the one or more optical channels 220. In some arrangements, the optical module 410 defines a reflective surface 410S configured to direct one or more optical signals L1 from transmission in a substantially horizontal direction (e.g., the direction DR1) to a substantially vertical direction (e.g., the direction DR2) away from the photonic component 20. In some arrangements, the optical module 410 includes a reflector 430 configured to direct one or more optical signals L1 from transmission in a substantially horizontal direction (e.g., the direction DR1) to a substantially vertical direction (e.g., the direction DR2) away from the photonic component 20. In some arrangements, the reflector 430 is on the reflective surface 410S. The reflector 430 may be or include a metal layer, an anti-reflective coating (ARC), or a material layer configured not to adversely affect the reflector 430 from reflecting or transmitting the optical signals L1. In some arrangements, the optical module 410 includes or defines a recess 410R2 defined by the reflective surface 410S. In some arrangements, the reflective surface 410S is formed by the recess 410R2. In some arrangements, the optical module 410 further includes or defines one or more recesses 410R3 at the edge portion 40E.

In some arrangements, the optical module 420 defines a reflective surface 420S configured to direct the one or more optical signal L1 from transmission in the substantially vertical direction (e.g., the direction DR2) to a substantially horizontal direction (e.g., the direction DR1) to an optical component 70 external to the optical director 40. In some arrangements, the optical module 420 includes a reflector 440 configured to direct the one or more optical signals L1 from transmission in the substantially vertical direction (e.g., the direction DR2) to a substantially horizontal direction (e.g., the direction DR1) to an optical component 70 external to the optical director 40. In some arrangements, the optical module 420 has an edge 420e configured to allow the one or more optical signals L1 to penetrate therethrough and reach the optical component 70. In some arrangements, the reflector 440 is on the reflective surface 420S. The reflector 440 may be or include a metal layer, an anti-reflective coating (ARC), or a material layer configured not to adversely affect the reflector 440 from reflecting or transmitting the optical signals L1. In some arrangements, the optical module 420 includes or defines a recess 420R2 defined by the reflective surface 420S. In some arrangements, the reflective surface 420S is formed by the recess 420R2. In some arrangements, the optical module 420 further includes or defines one or more recesses 420R3 at the edge portion 40e.

In some arrangements, the optical module 410 includes a protrusion 410P. In some arrangements, the optical module 410 includes or defines a recesses 410R1. In some arrangements, the optical module 410 is a single-piece structure having a protruding portion defining the protrusion 410P and concave portions defining the recesses 410R1, 410R2, and 410R3. In some arrangements, the optical module 420 includes a protrusion 420P configured to insert into the recess 410R1 to fasten the optical modules 410 and 420 to each other. In some arrange optical module 420 includes or defines a recess 420R1 configured to accommodate the protrusion 410P to fasten the optical modules 410 and 420 to each other. In some arrangements, the optical module 410 is connected to the optical module 420 through a locking mechanism (e.g., the recesses 410R1 and 420R1 and the protrusions 410P and 420P). In some arrangements, the optical module 410 and the optical module 420 are connected to each other through the engagement of the protrusions and the recesses. In some arrangements, the protrusion 410P engages with the recess 420R1 to connect the optical modules 410 and 420. In some arrangements, the protrusion 420P engages with the recess 410R1 to connect the optical modules 410 and 420. In some arrangements, the optical module 420 is a single-piece structure having a protruding portion defining the protrusion 420P and concave portions defining the recesses 420R1, 420R2, and 420R3. In some arrangements, the recess 410R1, the recess 420R1, the protrusion 420P, and the protrusion 410P are at a peripheral region of the optical director 40.

In some arrangements, the optical module 410 includes or defines a lens 410L, the optical module 420 includes or defines a lens 420L, and the lenses 410L and 420L are exposed to a cavity S1 defined by or enclosed by the optical modules 410 and 420. In some arrangements, the optical module 410 and the optical module 420 define an optical guider (e.g., the lenses 410L and 420L) exposed to a cavity S1 within the optical director 40. In some arrangements, the optical guider of the optical director 40 includes a lens 410L and a lens 420L facing each other. Surfaces of the lens 410L and 420L may be coated with a layer of ARC. In some arrangements, the optical module 410 is a single-piece structure with one or more concave surfaces defining the lens 410L. In some arrangements, the optical module 420 is a single-piece structure with one or more concave surfaces defining the lens 420L.

In some arrangements, the optical modules 410 and 420 are single-piece structures. In some arrangements, the optical modules 410 and 420 may include substantially the same structure. In some arrangements, the optical modules 410 and 420 are formed of silicon. In some arrangements, the recesses and protrusions of the optical modules 410 and 420 are formed by providing a silicon layer and performing etching operations on the silicon layer to form the recesses and the protrusions. In some arrangements, the optical modules 410 and 420 are formed of polymer. In some arrangements, the optical modules 410 and 420 including the recesses and the protrusions are formed by a molding technique (e.g., injection molding, nanoimprint lithography, or the like). For example, the optical modules 410 and 420 formed of polymer may be formed by injecting a polymer material into a mold and then demolding it. In some arrangements, the optical modules 410 and 420 are formed by the mold. According to some arrangements of the present disclosure, the optical modules 410 and 420 are assembled to each other to collectively construct a substantially rotationally symmetric structure, such that the optical modules 410 and 420 have substantially identical structures. Therefore, the optical modules 410 and 420 can be formed by using the same mold instead of two different molds, thus the manufacturing process can be simplified.

In some arrangements, a surface of the lens 410L is substantially parallel to the surface 201 of the photonic component 20. In some arrangements, a tangent of the surface of the lens 410L is substantially parallel to the surface 201 of the photonic component 20. In some arrangements, a surface of the lens 420L is substantially parallel to the surface 201 of the photonic component 20. In some arrangements, a tangent of the surface of the lens 420L is substantially parallel to the surface 201 of the photonic component 20. In some arrangements, the tangent of the surface of the lens 410L is substantially parallel to the tangent of the surface of the lens 420L.

In some arrangements, the optical director 40 includes director structures 40A and 40B and is rotationally symmetric with respect to a center axis C1 of the optical director 40. In some arrangements, the director structures 40A and 40B collectively form a structure that is 180° rotationally symmetric with respect to the center axis C1. In some arrangements, the director structures 40A and 40B define a plurality of lenses (e.g., the lenses 410L and 420L) exposed to the cavity S1 within the optical director 40. In some arrangements, a portion of the director structure 40A and a portion of the director structure 40B are exposed to air without being encapsulated by an encapsulant.

In some arrangements, the director structure 40A includes the recess 410R2 and is configured to switch a transmission direction of one or more optical signals L1 from one or more optical channels 220. In some arrangements, the director structure 40A is configured to optically couple an optical signal L1 from transmitting along a substantially horizontal path (e.g., the path P1) to a non-horizontal path (e.g., the path P2). In some arrangements, the director structure 40A has the reflective surface 410S defined by the recess 410R2 and is configured to switch the transmission direction of the optical signal L1 from the optical channel 220. In some arrangements, the director structure 40A includes a lens 410L facing the director structure 40B.

In some arrangements, the director structure 40B includes the recess 420R2 and is configured to switch the transmission direction of the optical signal L1 from the director structure 40A. In some arrangements, the director structure 40B is configured to optically couple the optical signal L1 from transmitting along the non-horizontal path (e.g., the path P2) to another substantially horizontal path (e.g., the path P3) different from the substantially horizontal path (e.g., the path P1). In some arrangements, the director structure 40B has the reflective surface 420S defined by the recess 420R2 and is configured to switch the transmission direction of the optical signal L1 from the director structure 40A. In some arrangements, the director structure 40B includes a lens 420L facing the director structure 40A. In some arrangements, the recess 230 of the photonic component 20 is configured for accommodating a portion of the director structure 40B.

In some arrangements, the recess 410R2 and the recess 420R2 define a rotationally symmetric cross-sectional profile. In some arrangements, the recess 410R2 and the recess 420R2 collectively form a structure that is 180° rotationally symmetric with respect to the center axis C1. In some arrangements, the non-horizontal path (e.g., the path P2) passes the lenses 410L and 420L. In some arrangements, the recess 410R2, the recess 420R2, the reflector 430, and the reflector 440 define the rotationally symmetric cross-sectional profile. In some arrangements, the recess 410R2, the recess 420R2, the reflector 430, and the reflector 440 collectively form a structure that is 180° rotationally symmetric with respect to the center axis C1. In some arrangements, the recess 410R2, the recess 420R2, the lens 410L, and the lens 420L define the rotationally symmetric cross-sectional profile. In some arrangements, the recess 410R2, the recess 420R2, the lens 410L, and the lens 420L collectively form a structure that is 180° rotationally symmetric with respect to the center axis C1.

The electronic component 50 may be disposed over and electrically connected to the substrate 10. In some arrangements, the electronic component 50 is electrically connected to the substrate 10 through the connection elements 85. The electronic component 50 may be a chip or a die including a semiconductor substrate, one or more integrated circuit devices, and one or more overlying interconnection structures therein. The integrated circuit devices may include active devices such as transistors and/or passive devices such resistors, capacitors, inductors, or a combination thereof. In some arrangements, the electronic component 50 may be or include a processing component, e.g., an ASIC, an FPGA, a GPU, or the like, or a combination thereof. The connection elements 85 may be or include conductive bumps, e.g., solder bumps.

The conductive wire 60 may be disposed over the substrate 10 and electrically connect the photonic component 20 to the substrate 10. In some arrangements, the conductive wire 60 electrically connects the conductive pad 213 to the conductive pad 110. The circuit layer 210 may be configured to receive an electrical signal from the electronic component 50 through the substrate 10 and the conductive wire 60.

The optical component 70 may be optically coupled to the optical director 40. In some arrangements, the optical component 70 is optically coupled to the photonic component 20 through the optical director 40. In some arrangements, the optical component 70 is configured to optically couple one or more optical signals L1 to or from the optical director 40. In some arrangements, the optical component 70 includes one or more optical fibers 72. The optical component 70 may be or include an optical fiber array unit (FAU). In some arrangements, the optical component 70 includes protrusions 70P configured to insert into the recesses 410R3 and 420R3 to be fastened to the optical director 40. In some arrangements, the protrusions 70P engage with the recesses 410R3 and 420R3 to connect the optical component 70 to the optical director 40.

The electrical contacts 81 may be disposed on the surface 102. In some arrangements, the electrical contacts 81 electrically connect to the conductive pads 120 of the substrate 10. In some embodiments, the electrical contacts 81 include solder elements or solder balls, e.g., controlled collapse chip connection (C4) bumps, a ball grid array (BGA), or a land grid array (LGA).

The adhesive element 83 may be disposed between the photonic component 20 and the substrate 10. In some arrangements, the adhesive element 83 connects the photonic component 20 to the surface 101 of the substrate 10. The adhesive element 83 may be or include a die attach film (DAF).

The adhesive element 92 may be disposed between the optical director 40 and the photonic component 20. In some arrangements, the adhesive element 92 adheres the optical director 40 to the surfaces 202 and 233 of the photonic component 20.

FIG. 1C is a top view of an electronic device 1 in accordance with some arrangements of the present disclosure. In some arrangements, FIG. 1A is a cross-section along a line 1A-1A′ in FIG. 1C.

In some arrangements, the photonic component 20 includes a plurality of optical channels 220 exposed by the surface 231 to the recess 230. In some arrangements, the recess 230 is defined by surfaces 231, 232, 234, and 235 (also referred to as “lateral surfaces” or “sidewalls”). In some arrangements, the edge portion 40E surrounds the recess 230 from a top view perspective.

In some arrangements, the optical director 40 includes a plurality of lenses 410L and a plurality of lenses 420L substantially aligned and overlapped with the lenses 410L. In some arrangements, the optical component 70 includes a plurality of optical fibers 72. In some arrangements, the recess 410R2 and the recess 420R2 extend in a direction substantially perpendicular to extending directions (e.g., the direction DR1) of the optical channels 220 and the optical fibers 72. In some arrangements, the reflector 430 and the reflector 440 extend in a direction substantially perpendicular to extending directions (e.g., the direction DR1) of the optical channels 220 and the optical fibers 72.

In some arrangements, referring to FIG. 1A and FIG. 1C, the director structure 40A includes the recess 410R2 and is configured to switch transmission directions of a plurality of optical signals L1 from the optical channels 220. In some arrangements, the reflective surface 410S is defined by the recess 410R2 and is configured to switch the transmission directions of the optical signals L1 from the optical channels 220. In some arrangements, the director structure 40A is configured to optically couple the optical signals L1 from a plurality of substantially horizontal paths (e.g., the paths P1) to a plurality of non-horizontal paths (e.g., the paths P2). In some arrangements, the director structure 40A includes a plurality of lenses 410L. In some arrangements, each of the optical channels 220 is configured to optically couple to one of the lenses 410L. In some arrangements, the director structure 40A includes the reflector 430 overlapped with the lenses 410L from a top view perspective.

In some arrangements, referring to FIG. 1A and FIG. 1C, the director structure 40B includes the recess 420R2 and is configured to switch transmission directions of a plurality of optical signals L1 from the director structure 40A. In some arrangements, the reflective surface 420S is defined by the recess 420R2 and is configured to switch the transmission directions of the optical signals L1 from the director structure 40A. In some arrangements, the director structure 40B is configured to optically couple the optical signals L1 from the plurality of non-horizontal paths (e.g., the paths P2) to a plurality of substantially horizontal paths (e.g., the paths P3) different from the paths P1. In some arrangements, the director structure 40B includes a plurality of lenses 420L. In some arrangements, each of the lenses 420L faces and is substantially aligned with each of the lenses 410L. In some arrangements, the lenses 410L are substantially overlapped with the lenses 420L from the top view perspective. In some arrangements, each of the lenses 420L is configured to optically couple to one of the optical fibers 72. In some arrangements, the director structure 40B includes the reflector 440 overlapped with the lenses 420L from a top view perspective. In some arrangements, the reflector 430 is partially overlapped with the reflector 440 from the top view perspective.

According to some arrangements of the present disclosure, with the optical director 40, an optoelectronic inspection by the optical component 70a can be performed before a singulation operation. Therefore, only the singulated units (e.g., photonic components 20 with the electronic components 30 disposed thereon) pass the inspection may be further connected to a substrate 10 to form the electronic device 1, and the singulated units (e.g., photonic components 20 with the electronic components 30 disposed thereon) fail the inspection may be discarded or reworked. As such, only the singulated unit considered as a “know-good-die” may be used to form the electronic device 1. Therefore, the manufacturing process of the electronic device 1 can be simplified without having to be reworked if the photonic component 20 of the singulated unit is determined to fail the inspection after singulation, and the cost can be reduced.

In addition, according to some arrangements of the present disclosure, the optical director 40 does not include a grating coupler but can function as a vertical coupler to direct optical signals upwards from the photonic component 20. Therefore, the optical director 40 can be used to optically couple optical signals of various wavelengths, unlike grating couplers that are wavelength sensitive. Therefore, the optical director 40 can support optical transmission of a relatively large wavelength range.

Moreover, according to some arrangements of the present disclosure, the optical director 40 can expand the beam size of the optical signals from the optical channels 220 and include lenses 410L and 420L2 that can collimate the optical signals. Therefore, the tolerance for optical coupling can be increased.

Furthermore, according to some arrangements of the present disclosure, the protrusions 70P engage with the recesses 410R3 and 420R3 to connect the optical component 70 to the optical director 40. Therefore, the electronic device 1 can include a detachable optical component 70, and thus the flexibility of increased.

In addition, according to some arrangements of the present disclosure, the optical director 40 is partially disposed in the recess 230 and connected to the surface 233. Therefore, the depth of the recess 230 may be designed or adjusted to control the passive alignment of the optical director 40 with the optical channels 220 and the optical component 70. Therefore, an improved passive alignment in substantially vertical direction can be provided.

FIG. 1D is a cross-section of a portion of an electronic device in accordance with some arrangements of the present disclosure. In some arrangements, FIG. 1D shows a cross-section of a portion of an electronic device 1 in FIG. 1A.

In some arrangements, referring to FIG. 1A and FIG. 1D, a surface of the lens 410L is inclined with respect to the surface 201 of the photonic component 20. In some arrangements, referring to FIG. 1A and FIG. 1D, a tangent of the surface of the lens 410L is inclined with respect to the surface 201 of the photonic component 20. In some arrangements, referring to FIG. 1A and FIG. 1D, a surface of the lens 420L is inclined with respect to the surface 201 of the photonic component 20. In some arrangements, referring to FIG. 1A and FIG. 1D, a tangent of the surface of the lens 420L is inclined with respect to the surface 201 of the photonic component 20. In some arrangements, the tangent of the surface of the lens 410L is substantially parallel to the tangent of the surface of the lens 420L.

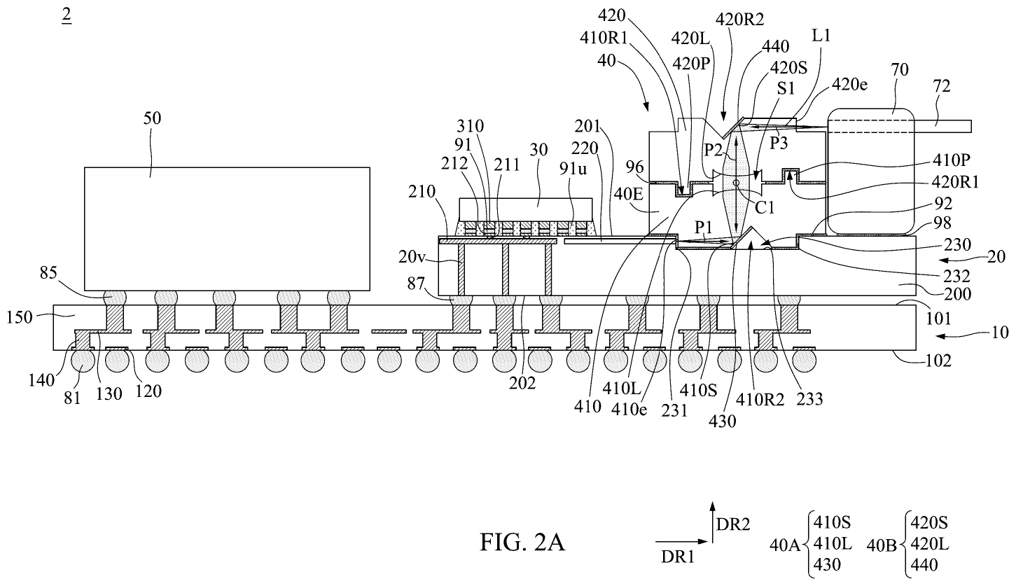

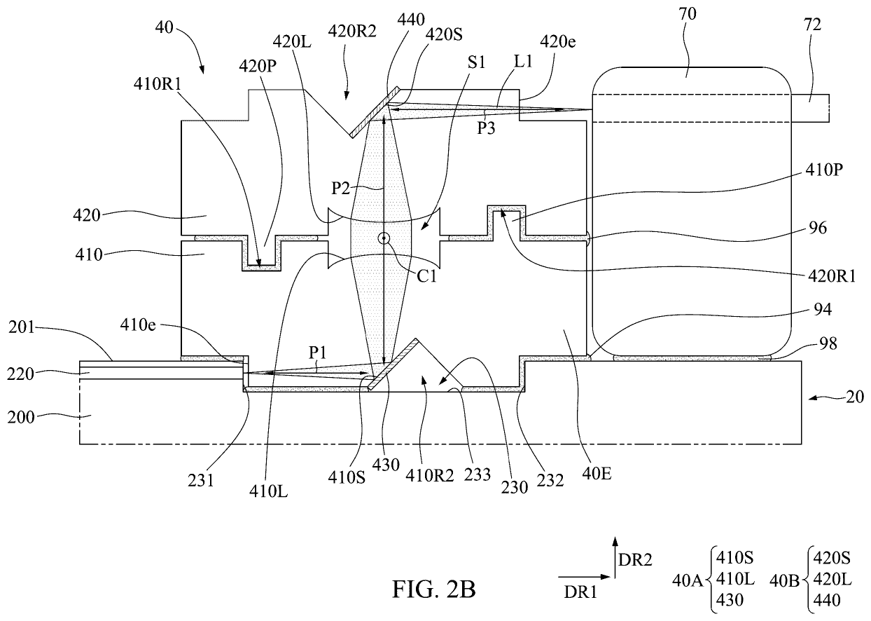

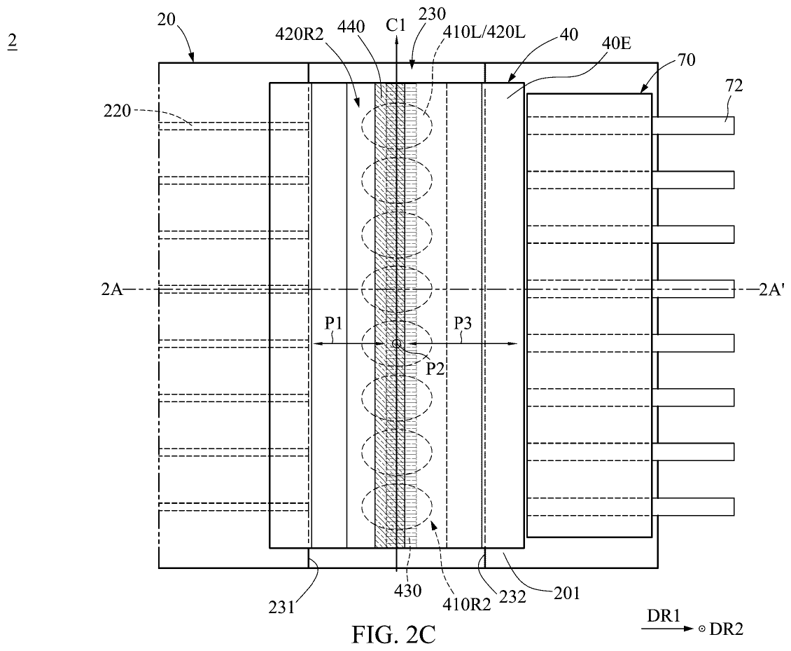

FIG. 2A is a cross-section of an electronic device 2 in accordance with some arrangements of the present disclosure. FIG. 2B is a cross-section of a portion of an electronic device 2 in accordance with some arrangements of the present disclosure. The electronic device 2 is similar to the electronic device 1 in FIG. 1A to FIG. 1C, and the differences therebetween are described as follows.

The electronic device 2 may further include connection elements 87 and connection elements 96 and 98.

In some arrangements, the photonic component 20 includes conductive vias 20v electrically connected to the circuit layer 210. In some arrangements, the photonic component 20 is electrically connected to the substrate 10 through the conductive vias 20v and the connection elements 87. The connection elements 87 may be or include conductive bumps, e.g., solder bumps.

In some arrangements, the optical module 410 is connected to the optical module 420 through the connection element 96. The connection element 96 may be free from protruding into the cavity S1. In some arrangements, the connection element 96 is free from covering the exposed portions of the optical channels 220. In some arrangements, the connection element 96 covers portions of lateral sidewalls of the optical modules 410 and 420. The connection element 96 may include a UV curable gel. The UV curable gel may be an optical gel which is transparent to the optical signals L1.

In some arrangements, the optical director 40 is connected to the photonic component through the connection element 98. The connection element 98 may include a UV curable gel. The UV curable gel may be an optical gel which is transparent to the optical signals L1.

FIG. 2C is a top view of an electronic device 2 in accordance with some arrangements of the present disclosure. In some arrangements, FIG. 2A is a cross-section along a line 2A-2A′ in FIG. 2C.

In some arrangements, the recess 230 extends beyond edges of the optical director 40. In some arrangements, portions of the recess 230 are exposed by the optical director 40 from a top view perspective. In some arrangements, the recess 230 is defined by the surfaces 231 and 232. In some arrangements, the edge portion 40E of the optical director 40 overlaps the surfaces 231 and 232 from a top view perspective.

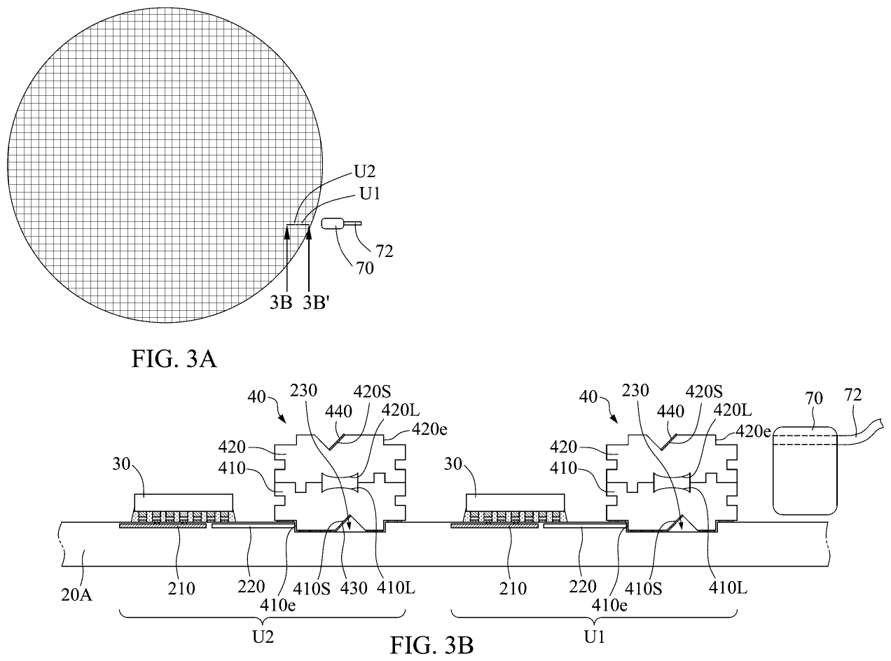

FIG. 3A is a top view illustrating one or more stages of an exemplary method for manufacturing an electronic device 1 in accordance with some arrangements of the present disclosure. FIG. 3B is a cross-section illustrating one or more stages of an exemplary method for manufacturing an electronic device 1 in accordance with some arrangements of the present disclosure. In some arrangements, FIG. 3B is a cross-section along a line 3B-3B′ in FIG. 3A.

In some arrangements, a wafer-level photonic structure 20A having a plurality of recesses 230 and a plurality sets of optical channels 220 exposed by the recesses 230 may be provided, and electronic components 30 may be electrically connected to the photonic structure 20A. The photonic structure 20A may include a plurality of units (e.g., units U1 and U2) each includes a recess 230 and a set of optical channels 220. Before the photonic structure 20A is singulated into singulated units (e.g., photonic components 20), an optoelectronic inspection may be performed on the wafer-level photonic structure 20A by disposing optical directors 40 in the recesses 230 of the photonic structure 20A to direct the optical signals from the optical channels 220 of the photonic structure 20A to an elevated position (e.g., the edge 420e) so as to optically couple to the optical component 70. In some arrangements, a singulation operation may be performed after the inspection is performed by the optical component 70. In some arrangements, only the singulated units (e.g., photonic components 20 with the electronic components 30 disposed thereon) pass the inspection may be further connected to a substrate 10 to form an electronic device. In some arrangements, the singulated units (e.g., photonic components 20 with the electronic components 30 disposed thereon) fail the inspection may be discarded or reworked.

In some arrangements, the optical director 40 may be connected to the photonic structure 20A or the photonic component 20 permanently after the inspection pass, and thus the singulated unit is considered as a “know-good-die”. Therefore, the manufacturing process of the electronic device can be simplified without having to be reworked if the photonic component 20 is determined to fail the inspection after singulation, and the cost can be reduced.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a photonic component comprising an optical channel; and
an optical director comprising a first director structure and a second director structure and is rotationally symmetric with respect to a center axis of the optical director, wherein the optical director is configured to optically couple an optical signal from the optical channel along a first substantially horizontal path toward a non-horizontal path.

2. The electronic device as claimed in claim 1, wherein the first director structure and the second director structure collectively form a structure that is about 180° rotationally symmetric with respect to the center axis.

3. The electronic device as claimed in claim 1, wherein the first director structure comprises a first reflector and a plurality of first lenses overlapped with the first reflector from a top view perspective.

4. The electronic device as claimed in claim 3, wherein the second director structure comprises a second reflector and a plurality of second lenses overlapped with the second reflector from the top view perspective.

5. The electronic device as claimed in claim 4, wherein the first reflector is partially overlapped with the second reflector.

6. The electronic device as claimed in claim 4, wherein the first lenses are substantially overlapped with the second lenses.

7. The electronic device as claimed in claim 1, wherein the optical director is configured to optically couple the optical signal from the non-horizontal path toward a second substantially horizontal path to optically couple the optical signal to an optical component external to the optical director.

8. The electronic device as claimed in claim 1, wherein the first director structure and the second director structure define a plurality of lenses exposed to a cavity within the optical director.

9. The electronic device as claimed in claim 8, wherein the photonic component further comprises a plurality of the optical channels, and the first director structure is configured to optically couple a plurality of the optical signals from a plurality of the first substantially horizontal paths to a plurality of the non-horizontal paths.

10. The electronic device as claimed in claim 9, wherein the non-horizontal paths pass the plurality of lenses.

11. An electronic device, comprising:
a photonic component comprising an optical channel; and
an optical director comprising a first optical module and a second optical module assembled to each other to collectively construct a substantially symmetric structure, wherein the optical director is configured to optically couple to the optical channel and direct an optical signal transmitted along at least two different directions.

12. The electronic device as claimed in claim 11, wherein the first optical module defines a first recess, and the second optical module comprises a first protrusion configured to insert into the first recess.

13. The electronic device as claimed in claim 12, wherein the first optical module comprises a second protrusion, and the second optical module defines a second recess configured to accommodate the second protrusion.

14. The electronic device as claimed in claim 13, wherein the first recess, the second recess, the first protrusion, and the second protrusion are at a peripheral region of the optical director.

15. The electronic device as claimed in claim 11, wherein the first optical module and the second optical module define an optical guider exposed to a cavity within the optical director.

16. An electronic device, comprising:
a photonic component comprising a plurality of optical channels;
a first director structure comprising a first recess and configured to switch a transmission direction of a plurality of optical signals from the optical channels; and
a second director structure comprising a second recess and configured to switch the transmission direction of the optical signals from the first director structure, wherein the first recess and the second recess define a rotationally symmetric cross-sectional profile.

17. The electronic device as claimed in claim 16, wherein the first director structure has a first reflective surface defined by the first recess and configured to switch the transmission direction of the optical signals from the optical channels.

18. The electronic device as claimed in claim 17, wherein the second director structure has a second reflective surface defined by the second recess and configured to switch the transmission direction of the optical signals from the first director structure.

19. The electronic device as claimed in claim 18, further comprising a first reflector on the first reflective surface and a second reflector on the second reflective surface, and the first recess, the second recess, the first reflector, and the second reflector define the rotationally symmetric cross-sectional profile.

20. The electronic device as claimed in claim 16, wherein the photonic component defines a recess recessed from an upper surface of the photonic component for accommodating a portion of the second director structure.
